(19) United States
(12) Patent Application Publication
(10) Pub. No.: US 2014/0367344 A1
(43) Pub. Date: Dec. 18, 2014

(54) Water Purification

(71) Applicant: WET Trust, Wellington (ZA)

(72) Inventor: Frederik Jacobus Faure, Paarl (ZA)

(21) Appl. No.: 13/979,622

(22) PCT Filed: Jan. 16, 2012
(86) PCT No.: PCT/IB2012/050191

§ 371 Date: Jul. 17, 2014

(30) Foreign Application Priority Data
Jan. 14, 2011 (ZA) 2011/00380

(51) Int. Cl. C02F 1/46; C02F 1/461

(52) U.S. Cl. CPC C02F 1/4606; C02F 1/46104; C02F 2201/46105
USPC 210/748.18; 210/192

(57) ABSTRACT

This invention relates to a method and apparatus (10) for purifying water, wherein oxygen is introduced into the water by electrolysis of the water; and the water is treated with at least one ionized transition metal. In a preferred embodiment of the invention, the electrolysis of the water takes place by passing an electric current through paired electrodes (22) made from stainless steel; and the water is treated with ionized silver, copper and zinc produced at silver (16), copper (18) and zinc (20) electrodes that are supplied with electric current. The invention prevents and combats growth of bacteria fungal and viral pathogens in water, and provides a non-toxic and environmentally friendly method of ensuring the public health in both public and private applications.

### BACKGROUND OF THE INVENTION

This invention relates to a method of purifying water and apparatus for use in such method.

Of all the water on the Earth, about 97% exists in the ocean as saltwater. The remaining 3% represents the amount of freshwater on the planet. Unfortunately, 90% of this freshwater is trapped in glaciers and ice caps, and in general humans cannot extract it for use. Ultimately, only 0.014% of the earth's total volume of water is easily available for agricultural, industrial, and domestic purposes. This water exists in a variety of forms, including soil moisture, groundwater, water vapour, lakes, dams and streams. This water is generally in a state which is not suitable for the above purposes.

It is an object of this invention to provide a method for enhancing the quality of water for agricultural, industrial, and domestic purposes.

### SUMMARY OF THE INVENTION

In a first aspect of the invention there is provided a method for purifying water, wherein:
oxygen is introduced into the water by electrolysis of the water; and
the water is treated with at least one ionized transition metal.

The electrolysis of the water may take place by passing an electric current through paired electrodes made from carbon, such as graphite, or an inert metal, such as platinum, stainless steel or titanium, preferably stainless steel.

The transition metal may be a non-ferrous transition metal, such as silver, copper, zinc, gold and/or platinum, preferably produced at transition metal electrodes that are supplied with electric current.

Preferably, the water is treated with ionized silver, more preferably ionized silver and copper, most preferably ionized silver, copper and zinc produced at silver, copper and zinc electrodes that are supplied with electric current.

The electric current supplied to the electrolysis electrodes and transition metal electrodes may be from 300 mA to 3 A, with the current to each electrode pair separately controlled.

Preferably, the water is maintained at a pressure of from 0.6 bar to 10 bar (6×10⁴ Pa to 1×10⁶ Pa), preferably from 2 to 6 bar (2×10⁵ Pa to 6×10⁵ Pa).

In a second aspect of the invention, there is provided an apparatus for treating water, the apparatus comprising:
means for introducing oxygen into the water by electrolysis of the water; and
means for introducing at least one ionized transition metal into the water.

The means for introducing oxygen into the water by electrolysis of the water may comprise paired electrodes made from carbon, such as graphite, or an inert metal, such as platinum, stainless steel or titanium, preferably stainless steel, through which an electric current may be passed.

The transition metal may be a non-ferrous transition metal, such as copper, silver, zinc, gold or platinum. Preferably the transition metal is silver, copper and/or zinc. Preferably, silver, copper and zinc are present in the apparatus.

The means for introducing at least one ionized transition metal into the water may comprise an electrode made from the transition metal, through which a current may be passed. Preferably, the apparatus comprises a silver electrode, more preferably silver and copper electrodes, most preferably silver, copper and zinc electrodes.

The transition metal electrodes may be connected, thereby forming electrode pairs. Each electrode pair may be connected to a DC power supply which is able to supply an electric current from 0-7 Amp separately to each electrode pair, with no limit on voltage. Preferably, the power supply is connected to a common power source, which may be a 220 to 240V AC or solar panel with polarity switching in a time frame of 3-10 minutes. The electrodes in the electrode pair may be placed apart at a distance of 18 mm or less, preferably at a distance of 8-10 mm.

Preferably, the means for introducing oxygen into the water by electrolysis of the water; and means for introducing at least one ionized transition metal into the water are housed in a vessel having a water inlet and a water outlet, for example a hollow pipe that may have a length of 0.5-3 m and a diameter of 50-350 mm, preferably length of 1-1.5 m and a diameter of 100-150 mm.

### BRIEF DESCRIPTION OF THE DRAWINGS

FIG. 1 is a diagram of the apparatus of the invention.

FIG. 2 is a cross sectional diagram of a preferred embodiment of the apparatus of the invention.

FIG. 3 is a schematic representation of an arrangement of the preferred embodiment of the apparatus of the present invention.

### DESCRIPTION OF A PREFERRED EMBODIMENT OF THE INVENTION

The invention allows for water to be disinfected by using the oligodynamic effect of transition metal ions on microorganisms in combination with the oxidative effect of nascent oxygen on bacterial enzymes and other organic material.

Transition Nonferrous Metal Ionization (TNMI) is an algaecide and biocide with successes in the bacteria, virus and fungi treatment. Not only does TNMI enhance water quality with a long term disinfection action, it also enhances the mineral content with specific benefits to human, plants and animals.

The oligodynamic effect of metal ions was discovered in 1893 by the Swiss Karl Wilhelm von Nägeli as a toxic effect of metal ions on living cells, algae, molds, spores, fungus, virus, prokaryotic and eukaryotic microorganisms, even in relatively low concentrations. This antimicrobial effect is shown by ions of: mercury, silver, copper, iron, lead, zinc, bismuth, gold, aluminum and other metals.

Metal ions, especially those of heavy metals, show this effect. The exact mechanism of action is still unknown. Data from silver suggest that these ions denature enzymes of the target cell or organism by binding to reactive groups, resulting in their precipitation and inactivation. Silver inactivates enzymes by reacting with the thiol groups to form silver sulfides. Silver also reacts with the amino-, carboxyl-, phosphate-, and imidazole-groups and diminish the activities of lactate dehydrogenate and glutathione peroxides.

Nascent oxygen oxidizes bacterial enzymes and other organic material. The reaction of nascent oxygen with bacterial enzymes and other organic material is instantaneous.

Metallic silver is one of the metals which are able to produce nascent oxygen. Among all the metals, silver is unique in its behaviour with oxygen. It is known that molecular oxygen is adsorbed on the surface of silver in its atomic state. Also, atomic oxygen diffuses more freely within silver than any other metal. Davies L. R et. al. (The development of function of silver in water purification and disease control), state that atomic oxygen fits very well in the octahedral holes of gold, silver, and copper. In gold, the electron cloud of oxygen tends to be repelled by the lattice electrons of the gold atoms stopping movement through the holes. With copper, the oxide is formed resulting in a barrier. Silver, with an almost perfect fit, offers so little repulsion that minimum thermal energy is required to move oxygen through the silver lattice, thereby producing nascent oxygen.

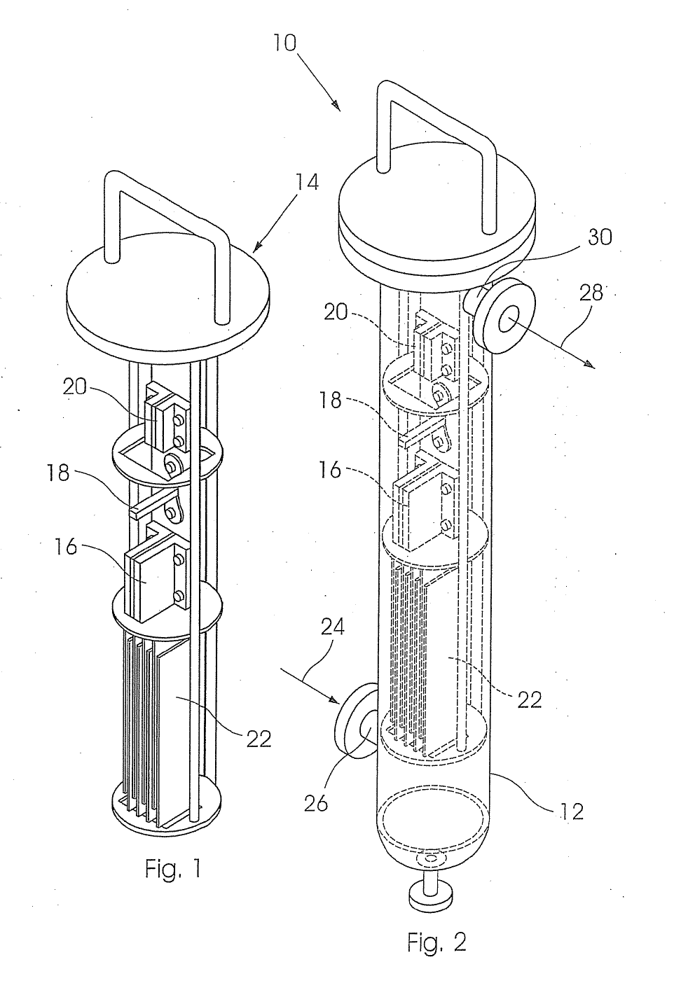

Referring to FIGS. 1 and 2, water is treated in a Transition Nonferrous Metal Ionization (TNMI) unit (10) comprising a vessel (12) in the form of a hollow pipe having a length of 1.2 m and a diameter of 110 mm, and an assembly (14) comprising a silver electrode (16), copper electrode (18) and zinc electrode (20) located inside the vessel (12). Each transition metal electrode is connected to another electrode, thereby forming separate electrode pairs. Electrodes in an electrode pair are preferably placed at a distance of 13 mm or less from each other preferably at a distance of 9 mm. Additional multi-stack electrodes may be added if needed, depending on the needs to be achieved. The assembly also contains a stainless steel electrode(s) (22), for electrolysis of water. Each electrode pair may be connected to a DC power supply, which is connected to a common 220V AC power source or solar panel, with polarity switching in a time frame of 3-10 minutes. The electrical current to each electrode pair is controlled separately.

Water to be treated (24) is supplied to the unit from a source via an inlet (26) to the vessel (12). The transition metal electrodes are ionized by supplying current to the electrode pair supplied directly to the electrode pairs from an external power supply. Typically molecular oxygen is present in the water that is being treated, although its concentration may vary depending on the factors such as the source of the water and the amount of minerals in water. Distilled water can absorb more oxygen than well waters with higher mineral content. For the same reason, sea water holds less dissolved water than fresh water. Oxygen is introduced into the water by electrolysis of water, using the stainless steel electrode(s) (22). Graphite, platinum, or titanium electrodes may also be used for this purpose. During electrolysis, water (H₂O) is decomposed into oxygen (O₂) and hydrogen gas (H₂) as a result of an electric current being passed through the water. A DC electrical power source is connected to multiple electrodes, typically made from graphite or an inert metal such as platinum, stainless steel or titanium, which are placed in the water. In an optimally designed unit, hydrogen will appear at the cathode (the negatively charged electrode, from where electrons are released into the water), and oxygen will appear at the anode (the positively charged electrode). Assuming ideal faraday efficiency the generated amount (moles) of hydrogen is twice that of oxygen, and both are proportional to the total electrical charge that was sent through the solution. Without wishing to be bound by theory, it is believed that oxygen produced by electrolysis is generated in its highly reactive, nascent form of a single atom. Because of its instability in nascent form, individual oxygen atoms quickly combine in pairs to form stable molecules of O₂. Electrolytic produce nascent oxygen, during its short lifetime, is a more potent oxidizer of bacteria than dissolved O₂, and hence a lower concentration is tolerable.

After electrolysis, the water comes into contact with the silver electrode (16), where ionized silver disinfects the water using the oligodynamic effect. The silver electrode also serves the purpose of producing nascent oxygen from the molecular oxygen already available in the water, or molecular oxygen made available in the water by injection of oxygen or the electrolysis of the water, or a combination of both methods. The available molecular oxygen is readily adsorbed on the surface of, and diffuses through the lattice of, the silver as nascent oxygen. The nascent oxygen instantaneously oxidizes the bacterial enzymes and other organic material in the water. If necessary, oxygen may be injected into the water (24), via an injector connected in series to the TNMI unit (1), prior to the water entering the TNMI unit (10). The water is further brought into contact with the copper and zinc electrodes, where it is further treated using the oligodynamic effect of ionized copper and zinc. The treated water (28) leaves the TNMI unit (10) via the outlet (30). Typically the water would be maintained at a pressure sufficient to maintain the supplied oxygen dissolved therein. The TNMI Unit is operated at a pressure of between 0.6 bar to 10 bar (6×10⁴ Pa to 1×10⁶ Pa and at a flow rate of 15000 to 25000, typically about 17000 to 20000 litres of water per hour.

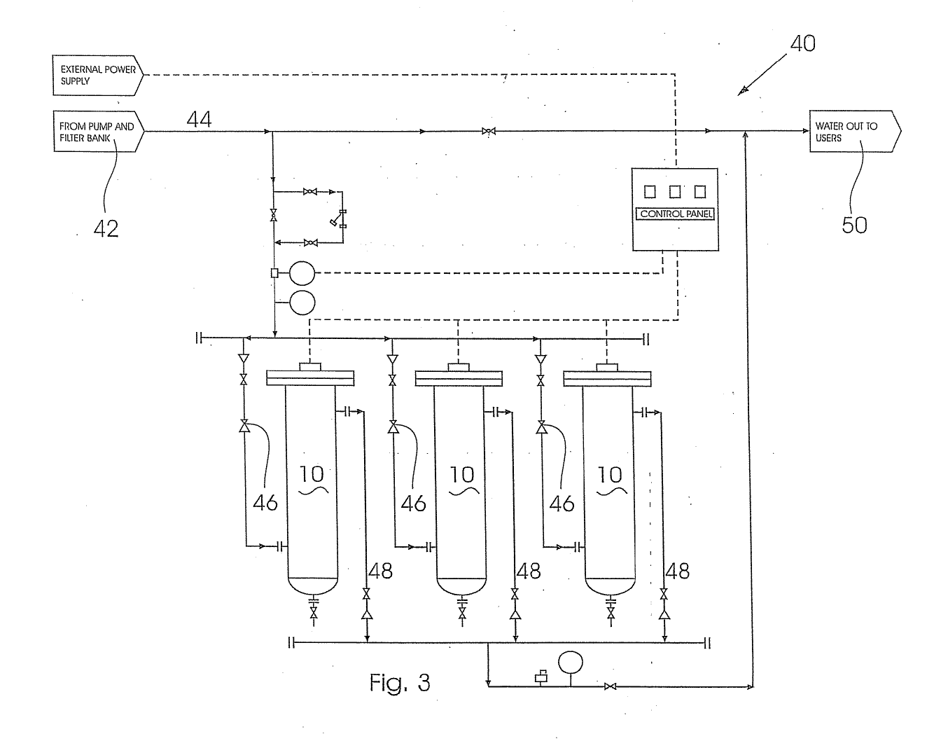

Referring to FIG. 3, the apparatus (40) of the present invention may consist of more than one TNMI Units (10) connected in parallel. The TNMI units may also be connected in series. Water to be treated (44) is fed from a source (42) to each TMNI unit (10) where it is treated as described above. Prior to entering the TNMI unit, oxygen is injected into the water via the injector (46), connected in-line with the TNMI unit (10). The treated water (48) is collected and supplied to a user access point (50), such as a tap, a swimming pool etc.

The apparatus also comprises a 220V AC (13) main power supply, and each TNMI unit contains a DC power supply (13) connected to each electrode pair, preferably with polarity switching, and which is able to change the current from 0-7 amp, within 3 to 10 minutes, per electrode pair, with no limit on voltage. The apparatus may also comprise indicators and alarms incorporated into the unit to indicate mains to the unit, DC to the TNMI unit, as well as current (Amp) status to each electrode pair.

The invention can be used in various applications such as pools, spas, fountains, Heating, Ventilating, and Air Conditioning (HVAC) equipment, cooling towers, wine industry, influent & effluent treatment, hospitals, food and potable water systems, irrigation systems, and various domestic, agricultural and industrial applications.

The invention can be used as a replacement of chlorine based water disinfection methods and still ensure primary and secondary disinfection abilities. It is also envisaged that the invention may be used in conjunction with other environmentally friendly water disinfection methods in order to ensure very high quality pathologically potable water results.

By preventing and combating growth of bacteria fungal and viral pathogens in water, the invention provides a non-toxic and environmentally friendly method of ensuring the public health in both public and private applications.

### EXAMPLE

Dam water from a site in Grabouw in South Africa was treated in a TNMI unit of the invention using a combination of ionization with copper, silver, zinc with electrolysis of oxygen.

Table 1 shows the results of an analysis of a sample of the water treated by the apparatus 10 described above with the vessel 12 having a length of 1.2 m and an internal diameter of 110 mm, by an independent laboratory.

The apparatus 10 was operated under the following conditions:
Pressure: 4 bar
Water flow rate: 19500 litres per hour
Power supply to electrodes: Single 12 VDC with a current supply between 300 mA to 3 A with polarity switching to each electrode pair.

The analysis showed a significant reduction in bacterial, fungal and viral pathogens within 2 seconds of starting the treatment.

TABLE 1

| | Lab. | Total | Coliforms/ | E Coli/ |
|---|---|---|---|---|
| Source | No. | Bacteria/1 ml | 100 ml | 100 ml |
| Dam | 5407 | 19200 | >2420 | 44 |
| 2 s after | 5408 | 200 | N/D | N/D |
| Treat | 5409 | 200 | 4 | N/D |
| Resv | | | | |
| Max. | | 5000 | 10 | 0 |
| allowed | | | | |

| Source | Lab. No. | Ag mg/l |
|---|---|---|
| Dam | 5407 | 0 |
| 2 s After | 5408 | 0.025 |

1. A method for purifying water, wherein:
oxygen is introduced into the water by electrolysis of the water; and
the water is treated with at least one ionized transition metal.

2. The method as claimed in claim 1, wherein the electrolysis of the water takes place by passing an electric current through paired electrodes made from carbon, or an inert metal.

3. The method as claimed in claim 2, wherein the inert metal is platinum, stainless steel or titanium.

4. The method as claimed in claim 3, wherein the inert metal is stainless steel.

5. The method as claimed in any one of the preceding claims, wherein the transition metal is a non-ferrous transition metal.

6. The method as claimed in any one of the preceding claims wherein the transition metal is silver, copper, zinc, gold and/or platinum.

7. The method as claimed in any one of the preceding claims, wherein the at least one ionized transition metal is produced at transition metal electrodes that are supplied with electric current.

8. The method as claimed in any one of the preceding claims, wherein the water is treated with ionized silver produced at silver electrodes that are supplied with electric current.

9. The method as claimed in claim 8, wherein the water is treated with ionized silver and copper produced at silver and copper electrodes that are supplied with electric current.

10. The method as claimed in claim 9, wherein the water is treated with ionized silver, copper and zinc produced at silver, copper and zinc electrodes that are supplied with electric current.

11. The method as claimed in any one of claims 7 to 10, wherein the electric current supplied to the electrolysis electrodes and transition metal electrodes is from 300 mA to 3 A, with the current to each electrode pair controlled separately.

12. The method as claimed in any one of the preceding claims, wherein the water is maintained at a pressure of from 0.6 bar to 10 bar (6×10⁴ Pa to 1×10⁶ Pa).

13. The method as claimed in claim 12, wherein the water is maintained at a pressure of from 2 to 6 bar (2×10⁵ Pa to 6×10⁵ Pa).

14. An apparatus for treating water, the apparatus comprising:
means for introducing oxygen into the water by electrolysis of the water; and
means for introducing at least one ionized transition metal into the water.

15. The apparatus as claimed in claim 14, wherein the means for introducing oxygen into the water by electrolysis of the water comprises paired electrodes made from carbon, or an inert metal, through which an electric current may be passed.

16. The apparatus as claimed in claim 15, wherein the inert metal is platinum, stainless steel or titanium.

17. The apparatus as claimed in claim 16, wherein the inert metal is stainless steel.

18. The apparatus as claimed in any one of claims 14 to 17, wherein the means for introducing at least one ionized transition metal into the water comprises non-ferrous transition metal electrodes, through which an electric current may be passed.

19. The apparatus as claimed in claim 18, wherein the non-ferrous transition metal is copper, silver, zinc, gold and/or platinum.

20. The apparatus as claimed in claim 18 or 19, wherein the wherein the means for introducing at least one ionized transition metal into the water comprises silver electrodes, through which an electric current may be passed.

21. The apparatus as claimed in claim 20, wherein the wherein the means for introducing at least one ionized transition metal into the water comprises silver and copper electrodes, through which an electric current may be passed.

22. The apparatus as claimed in claim 21, wherein the wherein the means for introducing at least one ionized transition metal into the water comprises silver, copper and zinc electrodes, through which an electric current may be passed.

23. The apparatus as claimed in any one of claims 18 to 22, wherein transition metal electrodes are connected in electrode pairs.

24. The apparatus as claimed in claim 23, wherein the electrode pairs are be placed apart at a distance of 18 mm or less.

25. The apparatus as claimed in claim 23, wherein the electrode pairs are placed apart at a distance of 8-10 mm.

26. The apparatus as claimed in any one of claims 14 to 25, wherein the means for introducing oxygen into the water by electrolysis of the water; and means for introducing at least one ionized transition metal into the water are housed in a vessel having a water inlet and a water outlet.

27. The apparatus as claimed in claim 26, wherein the vessel is a hollow pipe.

28. The apparatus as claimed in claim 27, wherein the hollow pipe has a length of 0.5-3 m and a diameter of 50-350 mm.

29. The apparatus as claimed in claim 28, wherein the hollow pipe has a length of 1-1.5 m and a diameter of 100-150 mm.

30. The apparatus as claimed in any one of claims 21 to 29, comprising a DC power supply which supplies an electric current to each electrode pair separately.
